(19) United States
(12) Patent Application Publication
(10) Pub. No.: US 2025/0336309 A1
(43) Pub. Date: Oct. 30, 2025

(54) DATA PROCESSING METHOD OF ANALYSING MUSICAL DATA IN THE CONTEXT OF EDUCATIONAL MATERIAL DATA

(71) Applicant: Thiiia Ltd., London (GB)

(72) Inventor: Felix Benjamin Weaver, Brentford (GB)

(21) Appl. No.: 19/064,763

(22) Filed: Feb. 27, 2025

(30) Foreign Application Priority Data
Mar. 29, 2024 (GB) GB2404605

(51) Int. Cl. G09B 5/06; G10H 1/00; G11B 27/10

(52) U.S. Cl. CPC G09B 5/065; G10H 1/0008; G11B 27/10; G10H 2210/061; G10H 2250/311

(57) ABSTRACT

A data processing method of generating a structured audio-visual presentation of educational material data, integrated with musical data, for output onto a display, comprising steps of: a) receiving a block of musical data representing a specific musical work; b) receiving a block of educational material data representing a specific educational material; c) processing the received block of musical data to determine and isolate musical elements contained in the block of received musical data to thereby generate a determined structure of the received block of musical data, including notes played by a plurality of instruments and vocal sounds including words and syllables in such vocal sounds; and d) processing the received block of educational material data to determine and isolate educational material elements contained in the received block of educational material data.

### TECHNICAL FIELD

The present disclosure is in the field of data processing and, specifically, data processing related to analysing musical data and educational material data.

### BACKGROUND

Since the invention of drawn images in 62,000BC, music in 40,000BC and writing/reading in 3400BC, humans have used digital technology to make these pre-existing analogue technologies, digital. What was carved on a wall, is now widely available, in high detail, editable and shareable, but it's still processed by the brain as imagery. If we could use digital technology and artificial intelligence to amplify human intelligence by improving our brain's processing capabilities rather than only providing more access and exposure, we could produce novel outcomes in human cognition. Depending on the mind of an individual, we as human's require information to be presented in certain ways to ensure we memorise it effectively. The primary method used in education involves both spoken and written words, which for many children and adults is not the most effective learning protocol. This has led to the development of mnemonic techniques; powerful tools to enhance memory performance.

An effective method for teaching children is to use melodic learning, where words and/or letters are encoded with audible tone (sounds/music). A famous example of this is the alphabet song, where a 26-note melody is sung or played. Children then remember the letters, as lyrics to a song, rather than trying to process, retain and recall a 26-letter monotone sequence. They then have to remember twice the amount of information, two 26-part sequences, rather than one. Yet the results are much greater, due to their capacity to process, retain and recall musical sequences. Melodic learning is done via spoken word from teacher/parent to child, using musical instruments, and via videos available online, on phones/tablets or television.

On the opposite end of the cognitive spectrum to children, adult memory athletes use visuospatial memory processing to obtain superhuman-level feats, such as recalling 70,000 decimals of Pi whilst blindfolded. This involves encoding sequential information onto a memory palace, a location built in the mind's eye (one's imagination) which has a specific pathway that is also memorised. Memory athletes encode objects into this memory palace in different ways, such as a book case they walk past with 4 books on a shelf, to represent the number 4. These spatial memory techniques are generated in the mind's eye, as internal visualisations, not available generally online or on phones, tablets or television.

Neurodivergent thinkers, such as those with autism, have been noted to have very high musical abilities by Leo Kanner in 1943. The Attention Deficit Disorder Association recommend learners with ADHD use short bursts of learning and mind-mapping, a spatial memory technique. People with dyslexia are advised to use multi-sensory input activities, such as flash cards and stories. Many studies have linked emotion and more specifically, dopamine and noradrenaline/norepinephrine to enhancements in memory formation and retention. These effects can be produced through listening to music and with engaging and/or dramatic storylines, as well as through rewards and gamification. Although many studies note release of hormones when listening to music, and the requirement of hormones to encode strong memories, there are no widely available learning protocols that specifically target hormone release for the purpose of improving cognitive function.

In conclusion, humans have a set of highly effective strategies to enhance memorisation, but they generally remain compartmentalised. Melodic learning remains in the domain of teaching children, as well as advertising through jingles. Spatial learning has remained mostly ‘non-mainstream’, used often by memory athletes and specialist teachers. Storytelling is also used primarily to teach children, but has also been compartmentalised for adults, in the form of documentaries and dramatisations of factual events. If a cognitive performance system was able to unify these effective methods of learning, and apply it to all academic material in a usable format, it could possibly provide a global boost in cognition and change the world in many ways. However, it is not obvious how all of these mnemonic techniques could be utilised at the same time, and within a single education program. Although there is an awareness of combining music and learning, with many playlists online named things like “music to study to”, there has not been a deep enough analysis of music, for the purpose of using it to improve cognitive function.

### SUMMARY

Disclosed is a data processing method of generating a structured audio-visual presentation of educational material data, integrated with musical data, for output onto a display, comprising steps of: (a) receiving a block of musical data representing a specific musical work; (b) receiving a block of educational material data representing a specific educational material; (c) processing the received block of musical data to determine and isolate musical elements contained in the block of received musical data to thereby generate a determined structure of the received block of musical data, including notes played by a plurality of instruments and vocal sounds including words and syllables in such vocal sounds; (d) processing the received block of educational material data to determine and isolate educational material elements contained in the received block of educational material data to thereby generate a determined structure of the received block of educational material data, including text and diagrams associated with the text; and (e) processing the determined and isolated musical elements in the received block of musical data and the determined educational material elements in the received block of educational material data, to determine synchronized time pairings of specific individual musical elements with specific individual educational material elements, by using the determined structure in the determined and isolated musical elements from step (c) and the determined structure in the determined and isolated educational material elements from step (d), where the determined synchronised time pairings are ordered sequentially for presentation onto the display as an audio-visual presentation.

Preferably, the steps (a) through (e) are carried out by an artificial neural network including: an input layer for receiving the block of musical data and the block of educational material data; at least one hidden layer for performing the processing steps; and an output layer for outputting a result of the processing steps for presentation onto the display.

Preferably, the audio-visual presentation includes at least one geometric pattern representing the received block of musical data.

Preferably, the method further includes a step of receiving a specified level or area of interest related to the specific educational material.

Preferably, the method further includes a step of receiving a storyline, including attributes comprising characters, art style and plot.

Preferably, the storyline is an anime cartoon storyline.

Preferably, the processing step (e) results in generating a video plan, setting out specific data regarding how the audio-visual presentation will be presented and played on the display.

Preferably, further including a step (f) of presenting the video plan onto the display to review and edit the video plan.

Preferably, characters from the received storyline are presented onto the display with animated educational material encoded onto at least one character.

Preferably, the at least one character is presented in the audio-visual presentation as moving in response to the determined structure of the received block of musical data.

Preferably, the steps (a) and (b) include receiving the blocks of data from a user, in response to the user being presented with options for selection on the display.

Preferably, the video plan includes a music stem file.

Preferably, the video plan includes written data points describing a result of the processing at steps (c) or (e), including a total number of sounds which have been identified by the processing.

According to another aspect, also disclosed is a system comprising means adapted for carrying out all the steps of the method as above.

According to another aspect, also disclosed is a computer program comprising instructions for carrying out all the steps of the method as above, when the computer program is executed on a computer system.

### BRIEF DESCRIPTION OF ACCOMPANYING DRAWINGS

FIG. 1 shows a preferred embodiment of a software program user experience and function sequence with output examples;

FIG. 2 shows a preferred embodiment of a software program expression of academic material via an audible geometric pattern, and also an example of a single pairing sequence of a drum loop to a diagram from an academic textbook;

FIG. 3 shows a preferred embodiment illustrating an example of a program or generative artificial intelligence model animating a diagram of an electrical switch to a particular lyric of a song;

FIG. 4 shows a preferred embodiment illustrating an example of prompts and data analysis to be made available within a program or generative artificial intelligence model,

FIG. 5 shows a preferred embodiment illustrating an example of how a program may build storylines to help drive emotion and context, and improve learning outcomes;

FIG. 6 shows a preferred embodiment illustrating an example design layout of a home screen, a music home screen, a subject home screen, a storyline home screens, and a settings or progress tracking home screen; and

FIG. 7 is a block diagram showing a preferred embodiment of a simplified design for an Artificial Neural Network to implement the disclosed technology.

### DETAILED DESCRIPTION

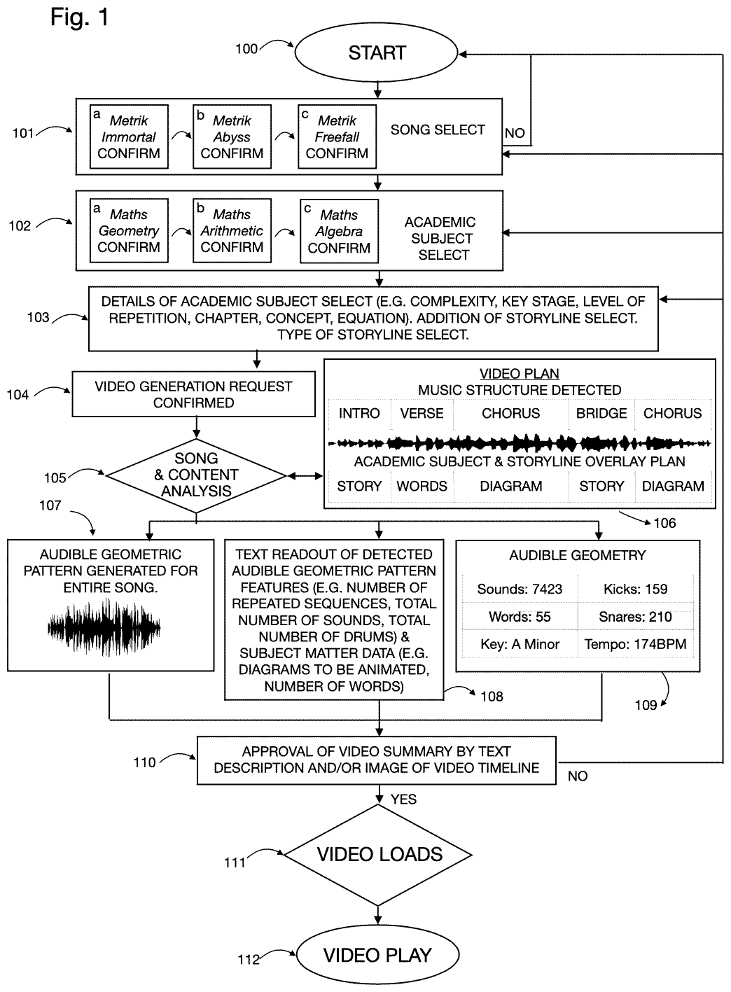

The software program in FIG. 1 shows a possible navigation through the program for a user of the program, according to a preferred embodiment of the disclosed technology. Starting point 100 represents a home screen of an education technology program or application, which may also include navigation buttons to other parts of the program, such as to a song selection section. In a preferred implementation, the education technology program makes educational videos, by using music to time the presentation of academic materials. The purpose for this is to help improve learning outcomes and provide entertainment that supports more engagement from the user. While a “screen” is described here, and below, any type of display, display device, or mechanism for rendering audio-visual content could also be used. For example, a hologram or augmented or virtual reality headset device, or the like, could also be used.

The user may then progress to a song selection screen 101, where they will choose from a selection of music available on the program or application. This could include popular music such as house music or drum n bass, as well as classical or jazz or any genre. In box 101a we see an Artist called Metrik and a song by Metrik called Immortal. Boxes 101b and 101c show that the user has navigated to other songs by the same artist, called Abyss and then Freefall. We see that the user may navigate through artists, songs, music genre in a similar way to the navigation on most smart phones in box 101. The user has now clicked on one of the ‘Confirm’ buttons shown in boxes 101a, 101b and 101c.

Now that a song has been selected, the user may then select from the available academic subject matter 102, such as academic materials from a range of subjects like mathematics (or “maths”), physics or engineering. In 102 we see that the user has selected Maths as a subject and is navigating through different branches/areas of maths. 102a shows Geometry as a possible branch of maths, 102b shows arithmetic, and 102c shows algebra. This shows us that the user can navigate through different subjects and branches of subjects manually in box 102, as they did with music in box 101. The user has now clicked on of the ‘Confirm’ boxes in the boxes in 102a, 102b, or 102c.

After selecting a subject and a song, the user may then select more specific settings on the subject matter 103. 103 shows us that the user has additional details that they may select, that are more specific than the subject branch/area. For example, selecting a ‘Complexity’ or ‘Key Stage’ may help the user ensure the academic material is appropriately challenging, based on their knowledge level of the subject they have selected, as well as their age. The ‘Complexity’ or ‘Key Stage’ may also guide the user, by showing them what content they may be presented with, including sections of a textbook (such as Edexcel GCSE Maths Foundation), particular diagrams (such as an Action Potential), principles or aspects of a subject (such as the 12 times tables). Selecting a ‘Level of Repetition’ may help the program limit the total amount of information that will be presented, which could support the user's learning outcomes, especially if they find the subject matter challenging. Selecting a ‘Chapter’ may be useful to a user who already knows a specific chapter of a featured textbook and wishes the program to only show content from that chapter, increasing attention on that chapter. Selection a ‘Concept’ may prompt the program to only show the content available that relates closely to specific area of a subject, which may include descriptions, diagrams, and equations. Selecting an ‘Equation’ may prompt the program to only show all of the information that relates closely to an equation, such as 2+2=4.

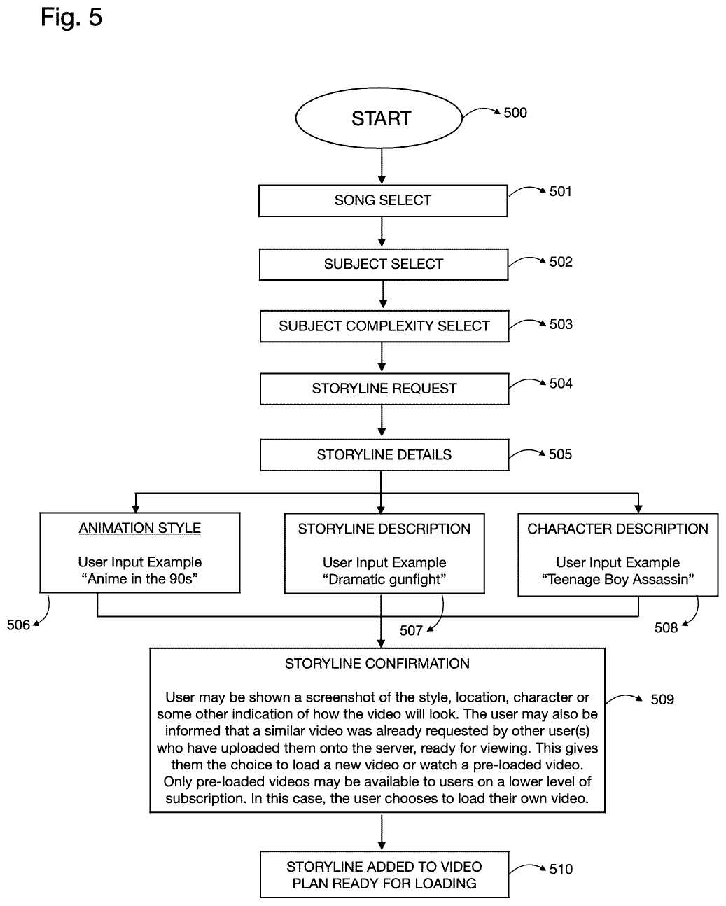

Box 103 also includes notes regarding the addition of Storylines. As will be shown in FIG. 5, the user may also select a storyline to be included in the video, possibly one that is in a particular artistic style, with a particular character description and a particular event taking place. The storyline may have user prompts that include descriptive factors, such as the gender of the character, the setting such as a city and an event such as a car chase.

Once a song has been selected 101, subject and branch selected 102, and additional subject details set 103, the user can confirm the request to generate an educational video 104. 104 shows us that the user has to confirm that they are happy with the selections they have made, and that they have manually confirmed that they would like the program to analyse the music, subject and their settings in order to progress to the next step.

Following the confirmation request at 104, the program or application will then analyse the song and subject matter 105. The program may be developed to do at least 3 things at 105. Firstly, the program may have been developed to identify the individual sounds and musical elements contained within music. Secondly, the program may have been developed to summarise academic materials, and to animate diagrams and images that relate to the academic material. Thirdly, the program may have been developed to create cartoon-style animations which include characters, backgrounds and motions. 105 represents a step before additional processing is needed, whereby the program has analysed the music, academic subject and any prompts regarding cartoon storylines. Using this analysis, the program has produced a plan for how the video might look to the user, as seen in box 106.

Box 106 of FIG. 1 represents a possible layout for how a plan may be shown to a user of the program, after the program has analysed the user's inputs. The user may see several bits of information, starting with a heading that says ‘Video Plan’ at the top. The next bit of information may be a heading stating Music Structure Detected, following by a chart that represents the structure of the song in a horizontal, linear way, indicating the length of the intro, verse, chorus, bridge and the 2nd chorus. Below this chart there may be a music stem, which looks like a horizontal line which has varying degrees of thickness. The music stem helps show the user what the louder parts of the song are, which adds more clarity to the structure of the music, such as the intro being quieter, with a thinner music stem shape in that section. A louder part of the song will almost always have a thicker section in the music stem, allowing even younger users to easily detect the general structure of music. Moving a step down again, there may be a heading that states Academic Subject & Storyline Overlay Plan. This heading may help the user to see how the structure of the music will link up with the academic subject matter, if they prompt the program to load the educational video. Below this heading, there may be another chart that indicates the following; the Intro to the song will be paired with Part 1 of a cartoon animation Story, the verse of the song will be paired with the Word Summary (Words) of the academic subject, the chorus of the song will be paired with Diagram Animations (Diagram) with Characters in the Background, the bridge of the song will be paired with a 2nd Part of the cartoon animation Story, and finally that the 2nd Chorus from the song will be paired with Diagram Animation (Diagram) from the academic subject. There may also be additional notes about what is included in the video plan, available to the user.

Although the storyline and the diagrams may be shown in separate parts of the educational video, they may also be overlayed on top of each other. An example of this would be a fight scene where an anime character extends his or her arm to punch. Underneath the character's arm, a diagram may appear which shows the angle under the character's arm (between the arm and the torso) matching the 90-degree angle shown within a diagram of a triangle. This helps add context to the meaning of geometry and drives more excitement and meaning into the subject.

Some users may wish to look in more detail at the different aspects of the information contained in 106. Therefore, FIG. 1 provides examples of Formats for presenting relevant information, shown as 3 boxes next to each other, 107, 108 and 109. These 3 boxes can be considered as examples of some of the information that may be available to the user, via navigation from the video plan in 106. Each one will be explained in the next paragraphs.

Box 107 shows a close up view of a music stem, with a description that refers to the music stem as Audible Geometric Pattern Generated for Entire Song. 107 may be presented to the user possibly by clicking on the music stem contained in the overview of the video plan in 106. The user may want to view the stem file in more detail for their own interest, and there may be options to view music stems of the drums or specific instruments as well. A purpose for 107 may be as follows; as we view the music stem visual shown in 107, the user might notice that the song structure has a very short intro (since the shape of the stem widens almost immediately) so the program may predict that a shorter intro storyline would fit well. This short intro may be represented by the first 5% of the song's total length, because the program has linked the short intro of the video, to the short intro of the music. This can be seen in music stem 107 thickening quickly on the left side, which represents the point where the music starts playing. But the user may actually want a very long intro story, or possibly they might only want to see diagrams animated to drums. This music stem shown in 107 may help guide the user to select songs with different structures that would help bring the structure of the video and the animation closer to what they had in mind, or what would help them learn better about the subject they are interested in. Alternatively, prompting for long intro's by the user, may help the program predict that both the intro and the 1st verse of music, rather than just the intro, should be paired with storylines, in order to comply with the prompts by the user.

108 includes examples of data available to the user. The heading states ‘Text Readout of Detected Audible Geometric Pattern Features’, to show us that the program will provide written data points about the analysis that has taken place, for the interest of the user. Examples are provided in 108 of this data, such as the total number of sounds the program has found after the analysis of the music. Each of these will be explained in the following paragraphs. 108 includes some examples of data points that may be highly unique to the program. Data points like repeated sequences, the total number of sounds (notes) and the total number of drums within a song are data points that are designed to support the musical literacy of the users, in a way that is unique. These data points are unlikely to be seen as particularly relevant in mainstream musical circles, but they become of great interest when each individual note and sound can be paired with visual information. By providing the user with the opportunity to pair academic material with each individual note and/or element in music, this allows for hundreds or even thousands of units of information to be encoded onto the music, within a single video. These data points in 108 also support the user's knowledge of what the program is analysing about the music, helping them to also understand the program better, which may support long term use and present opportunities for games where the users compete to guess the number of sounds in a song.

109 provides a rudimentary example of how some of the data mentioned in 108 may be presented to the user, in this case using a simple table format. 109 can be considered as similar data points that are mentioned in 108 but laid out in a way that may be what the user sees when using the program. 109 includes a heading that may say ‘Audible Geometry’, as this may be a niche way of telling the user about the structure of the song, that is unique and meaningful to the users of the program. 109 includes 6 examples of data points, such as the total number of sounds, the total number of words, the key of the song, the total number of kick drums, the total number of snare drums and the tempo in beats per minute.

Over time, the software program may be able to predict the kind of structures preferred by the user, without the user using specific prompts. For example, the user might like music with lots of individual notes in the chorus, rather than songs with a chorus that is more based on lyrics. The program may be a generative artificial intelligence model that has been trained specifically, including with human involvement, regarding what sounds or musical elements generally link well with certain elements of animation. Examples may include the timing of the most important sequence of academic information, being paired with the most prominent and memorable part of the vocals in the chorus. This may be because the ability to memorise the chorus could help to improve the memorisation of the academic material it is paired to.

110 shows a step within the navigation towards the end of the user's process of building an educational video, which may be visible to the user in the form of a button that says the word ‘Approve’ or ‘Go’ or it may have an image of an arrow that indicates progression to the next stage. Once the user has approved the video 110 through a click, drag or interaction of some kind, they can confirm their desire to have the program load the video 111. Alternatively, if the user decides they would like to revert back to select a new song at 101, to select a new subject at 102, or to review and adjust more specific elements of the content at 103, they may do so via navigation from 110 (see the yes and no navigations attached to box 110).

111 represents a process where the program uses all of the information in the analysis, including the music, academic materials and user prompts, to generate a video. The loading phase 111, is where the program will connect the sounds in the music with the various elements of the subject matter. 111 shows the process of the video loading, during which time the user may be shown a loading bar, or some other visual representation of something being loaded. Once the video has loaded 111, it will then be ready for play 112. 112 may be a button that appears or lights up, only once the video loading from 111 has completed. 112 concludes the end of FIG. 1.

Iterations of the program may be produced that change the ordering of the user experience, such as selecting a single diagram to animate, followed by selecting various songs. This would be an option for users who may be going into important exams about specific subject matter. The program may include, whether via automation or manual entry by the user or central automation based on user preferences or needs, two primary inputs and one primary output. The two primary inputs are music and a subject for learning. The primary output is a video that features the selected subject matter input animated to the music input.

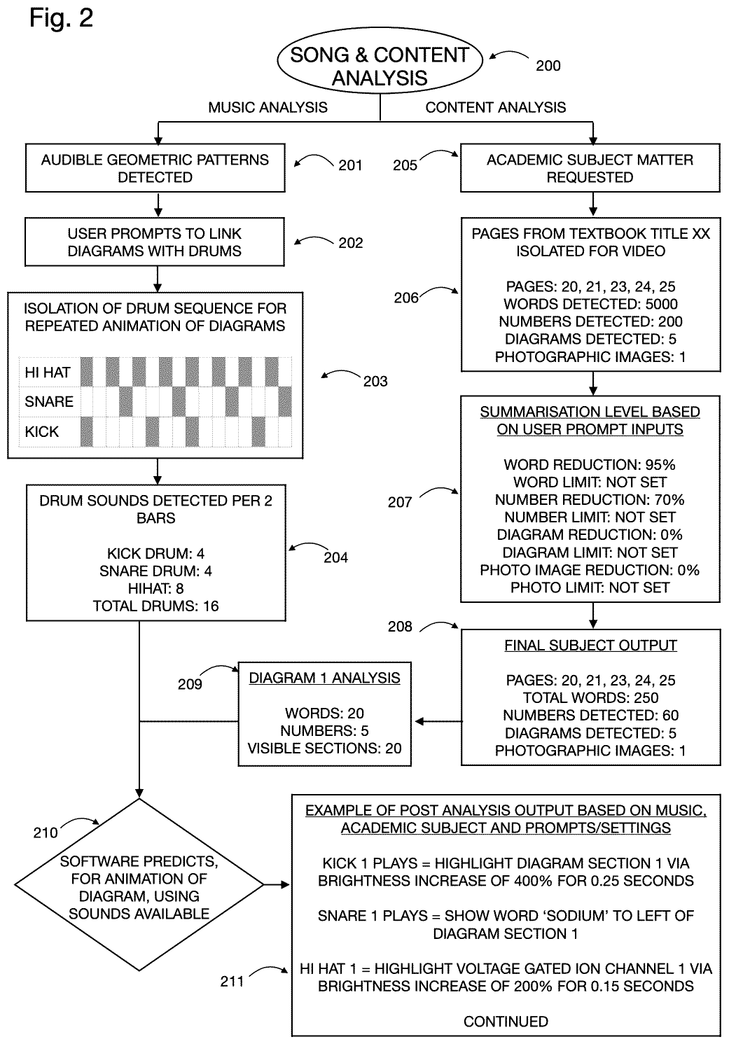

FIG. 2 shows a specific set of functions, within a program that uses the structures in music, to time the presentation of academic material, and make an educational video out of the combination of the two.

FIG. 2 shows details of how the program may function on the back end and includes examples of settings or preset options that may be selected by a user of the program. FIG. 2 shows the functions of the program in some detail, with focus and examples of how the program will use individual sounds within music to time the presentation or animation of academic material to make an educational video. FIG. 2 begins after the analysis of both the music (1 song) and academic material (a subject such as maths and a subject level such as key stage 3) in 200. 200 says Song & Content Analysis, which tells us that a process has occurred, whereby the program has analysed both a song and also content from an academic subject. The boxes in FIG. 2 are to be considered as back end functions of the program, meaning that they are instructional steps that a software engineer may use to create code to produce a set of functions.

FIG. 2 splits the functions down 2 pathways, which then converge when the program has predicted the most optimal pairing sequence between the sounds in the music and the visual content of the video. The first pathway, on the left side of FIG. 2, is the music analysis pathway, which involves analysing the content of the music to determine information such as the number of notes, the overall structure of the song and the lyrics, as well as the syllables in the lyrics. The second pathway is the subject analysis pathway, which involves analysis of the particular area of a subject as it's presented in a textbook that has been pre-loaded into the program or used as content for training in the case of the program being a generative artificial intelligence model. This analysis would include data points such as the number of diagrams associated with the subject area, the number of words in the chapter of the textbook that covers the subject and the number of numbers/symbols included in the relevant chapter.

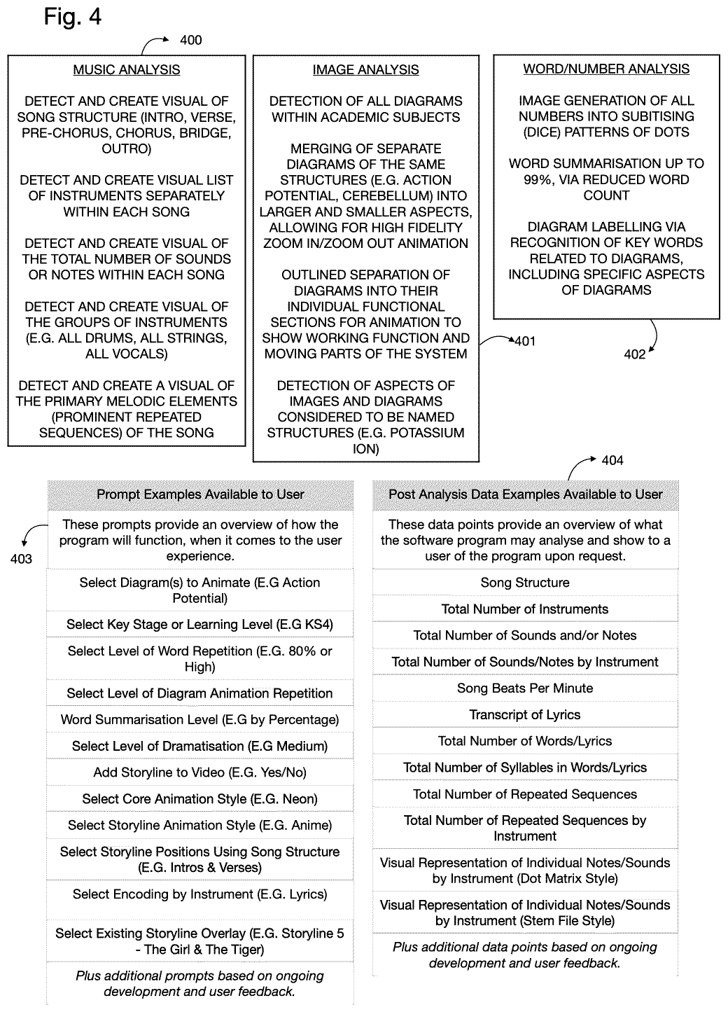

During the music analysis, the program will detect the patterns in the music 201. 201 represents a specific stage of the function of the program. Examples of these patterns may include the number of notes in a riff that repeats during the chorus of a song, the number of syllables in the lyrics in the verse, or the pattern of the kick and snare drums. Within these patterns, there may be many 100s or 1000s of individual notes/sounds, detected by the program. In this example shown in FIG. 2, the user of the program has prompted the program, via the settings (examples of settings and preferences found in FIG. 4), to link diagrams with drums 202. 202 represents the scenario of a user who has already prompted the program, likely via the manual Settings. Examples of these settings can be found in FIG. 4, under the table showing ‘Prompt Examples Available To User’.

The music analysis at 201, combined with the user setting 202, prompt the program to isolate drum patterns within the song 203. 203 shows a possible, user-friendly visual example of what the program has detected in the song analysis. The program has ready-made positions for the different types of drums, such as the kick, snare and a hi-hat. 203 provides an example of what may be shown in a clear visual format via the filling of the empty spaces, at the points where drums are detected, with time being represented as a left to right linear pathway, which starts on the left. As well as presenting the information in a visual format using graphs, charts or other types of images 203, the program may also present information about the drums as numerical and worded data that can be presented to the user 204. 204 provides an example of this, showing a brief description of the drums that were detected within 2 bars of music.

To summarise, before moving onto the Content Analysis pathway on the right side of FIG. 2; the program now likely has several prompts, including linking diagrams of a particular subject with drums, and also prompts about the content of the subject matter, with many examples available in FIGS. 4. 203 and 204 have now provided an example of some sounds or notes contained within the song, that were detected at 201 through the analysis at 200. This means that the program now has a framework that can support the presentation of academic material, since the program is designed to use the patterns in music to time the presentation of imagery for the purpose of education and entertainment. This means we are ready to look at the other analysis pathway in FIG. 2, which is the Content Analysis pathway.

Whilst the music analysis pathway provides examples of the sequence for how the program may analyse music, the content analysis pathway provides similar examples, but for the analysis of academic material. FIG. 2 provides both pathways alongside each other, in order to provide clarity on the idea that the program must analyse both music and academic material separately, in order to link them together afterwards. Although FIG. 2 provides a step by step sequence of examples, the program may have such information pre-loaded or it may be pre-trained on these materials, in order to reduce loading times for the user. However, regardless of when exactly these pathways occur, both are relevant in understanding how the program functions, and therefore they are included alongside each other in FIG. 2 to help explain the general process of analysis.

During the content analysis 200, the program has already been prompted by the user to analysis a particular area of a particular academic subject 205. 205 provides an indication of this as a confirmed step in the sequence. An example of academic subject matter may include a particular area of maths, at a particular key stage, such as key stage 2, and a specific area of maths at that level, such as multiplication. The program may predict that the user wants a set of pages from a particular online textbook 206, based on their inputs and settings. An example of the textbook could be a chapter from Schofield & Sims Key Stage 2 Maths. 206 provides an example of the output that the program may detect and it presents an analysis of the content of the subject, by stating such information as the number of words detected and the number of diagrams. The program may also be advanced, via human and artificial intelligence assisted training modalities, to understand the number of principles in the subject matter (meaning the primary chunks of information within the area being analysed). Such detection capabilities may contribute to faster learning outcomes for users. Once the program has analysed the content of the subject matter requested, it can use the settings and/or prompts to alter the content to match the needs of the user 207. 207 helps to show the sequence that occurs after the initial analysis of academic materials. 207 provides examples of what the settings, prompts and preferences found under FIG. 4 may do to support the management and re-formatting of academic material. This is important because the individual user can receive very different outputs from the program, despite using the same song to cover the same academic subject matter. 207 shows an example of how a user may have stated such request as, reducing the word count or summarisation by a certain percentage, such as 95%. After the program has analysed the content 200/205/206 and used the settings and prompts to alter the content 207, it can generate a new set of information, based on the combination of these activities 208. 208 shows how the program has predicted the output, based on the content and settings requested by the user. 208 helps explain that the program may predict that only the most important key words will be presented on-screen during the video, along with lots of repetitions of diagram sequencing, since the word count may be reduced by close to 95%, leaving the program to only select key words to make up the remaining 5%.

Since it is beyond the scope of a single flow chart to explain all of the aspects that will be analysed and summarised by the program after 208, FIG. 2 explains the analysis regarding a single diagram instead 209. This diagram is to be seen as part of a broader range of visual material, whilst allowing some specific explanations as to how the sounds detected in music will be connected with the words and images summarised from the academic material.

As part of the new set of information contained in the academic subject area 208, that has then been summarised 207 by the program based on the user settings, the program in this example has detected a diagram and used the settings and prompts in 207 to restructure the information in the diagram 209. An example of a diagram could be an action potential in a neuron, with cell membrane and sodium and potassium ions travelling across the membrane. The program may understand how to animate the diagram, ensuring it shows the transfer of sodium and potassium. The program may also use its predictive function or training, to determine that the diagram has, for example, 20 different sections that can be animated to show it functioning 209. Although a diagram of an action potential may have many several features, it may have 20 different sections when looked at in the level of detail that the program will, as noted in 209. Examples of these aspects may include the sodium ions, potassium ions, cell membrane, voltage gated ion channels, membrane potential gauge, etc. These predictions made in 209 about the number of aspects in diagrams and the number of words, may be made possible via training modalities related to the development of generative artificial intelligence models, such as pre-training, fine-tuning, and/or reinforcement learning from human feedback.

Following the analysis and predications about a particular diagram related to an academic subject at 209, the program may now begin the process of pairing the academic material with the sound in music, based on both bodies of content and any related user settings. This is why 204 and 209 now converge at 210 in FIG. 2.

The program can now use the information contained within the drum pattern in 204 and combine it with the information in the diagram 209 and create an animated sequence which animates the diagram to the drum sounds in music 210. 210 represents a process whereby the program predicts how to appropriately animate and present the diagram, based on a combination of the structure of the music provided, the user settings, and how the pre-loaded academic material is described by the textbooks it has been pre-loaded with or trained on.

In the example in FIG. 2 at 211, the program has been prompted by the user to look at the academic subject of neuroscience, specifically action potentials. The program has predicted the best way to link some of the aspects of the diagram of the action potential to the sounds in the music, by time-pairing them together 211. Some details of this include that the program will show a part of the diagram lighting up 400% at the moment a particular kick drum plays in the music 211. This may be a method of bringing attention to a change in state of a particular area of the animation of a diagram, that draws the user's attention, allowing for greater learning outcomes. The program may have predicted that lighting up the diagram is the correct method of animation, via prompts from the user, settings set by the user, via its training in the case of a generative AI model, or centrally by the developers.

The program has continued to link additional drums to other parts of the diagram, based on all the inputs and settings, the content of the diagram, the drums in the music and any training or programming done by its developers 211. 211 explains very specifically about the intricate functions of the program, as it alludes to how many possible opportunities there are to animate or present information in time to the individual sounds in music. 211 also demonstrates that a single sound within a song, of which there may be 100 s or 1000 s, can produce different types of animation for a varied amount of time, including lighting it up, zooming in or out, making it visible or non-visible, changing its colour, overlaying it on top of an anime story, or firing it rapidly into a larger diagram to form one of the component parts. Another example of animating diagrams to enhance spatial learning, is to rapidly build entire diagrams in time to the sounds or elements in music. Drums in music like drum n bass, may be used as timing mechanisms for such a build method of animation, producing a fast understanding of each individual component of the diagram. This may support the user's understanding of the spatial elements of a diagram, since they observe the individual component parts, as they would do if they were building the diagram themselves. Furthermore, the individual parts of such diagrams are likely to be time-paired with musical notes or elements, adding the benefits of melodic learning to a highly effective mnemonic animation technique. These techniques serve the purpose of aiming to help the user observe the academic materials with a timed structure, which may allow their brain to more easily encode/process and memorise the information, than they would do via other methods of learning the academic material.

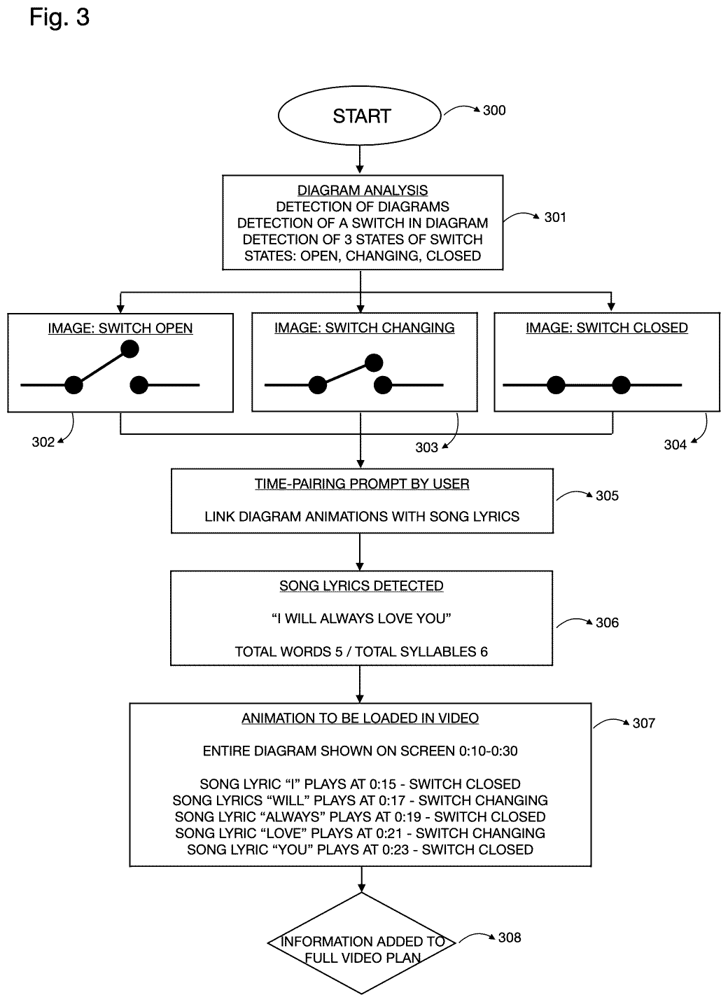

FIG. 3 shows in the most simplistic terms, how the program may animate imagery, using the elements of sounds in music. This imagery and the music will be presented as part of an educational video that teaches the user about an academic subject. The program may be making 10s, 100s, or 1000s of animations at any given time. Although there will likely be many of these moving parts and aspects within some diagrams, this flow diagram helps to show how a single image of a switch found on a diagram related to electronic circuits could be animated. This switch may form one of many moving parts of a larger diagram, with multiple animations occurring simultaneously, timed to various sounds in music.

The program would be prompted to analyse a song and a body of subject matter 300. 300 represents a starting point that is several stages into the program's process of generating imagery in time to music, allowing FIG. 3 to focus entirely on a single animation sequence. 300 begins after several inputs by the user have occurred, which may include the selection of a song such as Immortal by Metrik, and the subject of neuroscience, specifically action potentials and a focus on voltage gated ion channels. As most subject matter includes diagrams, the program has detected a diagram within its analysis of an online textbook 301. An example of this textbook may be Neuroscience: Exploring The Brain (4th Edition) by Bear, Connors and Paradiso. 301 shows that an analysis has taken place of a diagram, that the program understands the diagram is a switch, that the switch has 3 states/positions, and the states/positions are noted as being open, closed and shut.

FIG. 3 shows that the program has detected different segments of a diagram of a switch in an electronic circuit. In some textbooks, there may be multiple repetitions of the same diagram, since a textbook is limited by static images. Since the program has the ability to animate images, it's development process has enabled it to predict that several diagrams on a page of an online textbook are of the same diagram, but in different states. The switch in this diagram has 3 different states. They are shown in 302 (open), 303 (changing), and 304 (closed). What was 3 diagrams in the textbook, is now 1 diagram in the video made by the program, due to its function of predicting how to optimise the presentation of academic materials.

305 shows that the program may predict that the most prominent song lyrics are the ones that are most repeated. The program predicts that the diagrams can be simplified by being merged into one, so that the change of state can be animated more simply, in a single moving diagram, which is time-paired with particular song lyrics 305. 305 shows how the prompts by the user may be integrated into the process of animating academic material.

306 shows that the program has also detected song lyrics, for example, ‘I Will Always Love You”. It may predict that the most prominent song lyrics are the ones that are most repeated, predicting them to be the song's chorus. The program's analysis of the song, shows 5 words with 6 syllables, possibly repeating in a chorus, which it has been programmed to predict as the primary lyrical element of the song. The program has used this prediction function 306, along with prompts from the user 305, to animate the diagram from 301.

307 shows that the program has unified the music, the diagram and the user settings into a specific set of animation instructions. The program predicts that the diagram should remain on screen for a total of 20 seconds, based on its prediction of the complexity of the subject and the user's settings and prompts in this example 307. It may be that this length of time also fits with a segment of the song and is enough time to show enough repetitions occurring for the user of the program to encode it into their memory. The program has predicted that a way to show the animation taking place, is to change the image of the switch at the moment in time that particular lyrics to the song are played 307. 307 shows how each individual syllable, in the lyrics “I Will Always Love You”, will be used as timing mechanisms to animate the movement of the switch in the educational video that the program will produce for the user.

308 shows that this set of instructions forms part of the process for making a full video. The program has now set up the animation sequence, by combining the analysis of static diagrams with the lyrics it found in the song analysis. This sequence, which may be 1 of many 100 s, 1000 s, or >10,000 s in a single video, can be added to the full video to be loaded up and played by the user at a later stage beyond 308. In a real video example, there may be switches animated to lyrics, whilst particles travel across the cell membrane where the action potential is taking place, in time to kick and snare drums.

FIG. 4 provides a list of possible functions that may be included in the program, for the purpose of enhancing the user experience and improving outcomes in learning. Prior to writing the code that will run the program, the design foundation and navigation of the program will be drawn out in detail. This may include the desired processes and outcomes, as these instructions will lead the process of the program's development. By using non-technical, broad language to describe these functions, it allows team members involved in the development process to communicate effectively. It also allows for users of the program to translate feedback, even if they don't have a background in software engineering.

The music analysis notes in 400 includes some of the functions of the program to take music audio files or music compositions and analyse them to produce accurate reports about the individual sounds and musical elements contained within the music. Such information may include the structure of the song, the number of instruments, the number of notes played by a particular instrument and other detailed information. The program will also need to provide more broad information about the music, such as the tempo and genre. Furthermore, the program may be developed to express this information in numerical formats, but also in diagrams. Such a diagram may show sequences of lines or dots, sequences of letters from A to F or specially design tables that are developed in a way that make viewing them aesthetically pleasing to users of the program.

The image analysis in 401 revolves around detecting diagrams and images, especially those that are repeated often both within and across different subjects. An example may be the adenosine triphosphate molecular structure diagram, likely to be found in textbooks about biology, physiology, nutrition and biochemistry. The program may use extensive training across multiple textbooks, to create high fidelity versions of such diagrams, by predicting the zoomed out and zoomed in versions of these diagrams. An example might be that the program has developed an image of the adenosine triphosphate molecule but has also developed another image of the adenosine separately, plus another image of an atom, and so on. Examples of where these 3 diagrams may be found are Nutrition and Enhanced Sports Performance (2nd Edition) by Batch, Nair and Sen; Principles of Biochemistry (International Edition) by Nelson and Cox; and University Physics with Modern Physics (Global Edition) by Young and Freedman. This may allow the program to predict that by zooming into adenosine, it can show internal functions changing when adenosine is connected to phosphate molecules, becoming adenosine triphosphate. This may support better learning outcomes, since the human visual system is much faster at recording information, allowing the program to provide deeper context to subjects. In this case, the greater context may be to do with electrical charge or energy release, which is complex, but can be explained visually by the program having access to multiple images and then combining them together.

The word/number analysis in 402 is relatively more simple than the music and image analysis, since summarisation and the pairing of numbers with dotted sequencing (subitising) are widely utilised across the world already in models such as Chat-GPT. Preferably, the present disclosure is related to words and numbers, and will involve the pairing of words appropriately with images and diagrams. Appropriate pairing examples would be to know the word ‘adenosine’ may be paired with the presentation of a particular set of diagrams that show adenosine. The word analysis may also require the prediction of words related to adenosine based on the settings, prompts and subject matter. Examples of words associated with adenosine may be phosphate, receptor, caffeine, and many more.

Prompt examples in 403 may be provided to developers, so they can develop functions, code and the navigation. Prompts are likely to be things like the selection of diagrams. If a student has a text on the cerebellum for an advanced neurology degree, they may wish to isolate such a diagram and have it animated to music. The animation may show the function sequence many times over and over, helping them to encode the cerebellum's functional sequences into their memory, ahead of the exam. Another prompt may be to select dramatisation. A young teenager may find it difficult to focus but loves watching martial arts. He may increase the storyline elements of his videos to include high dramatisation. This may prompt the program to delivery more rapid, flashing images of swords clashing as 2 characters battle, interspersed with Key Stage 3 Maths subjects.

Developers of the program may also create functions for users that are purely related to tracking and presenting raw data. Examples of this found in 404 may be to state the total number of sounds within a particular song, including all instruments, vocals and drums. Another example of such data may be visual representations of these sounds, where the user may see the total number of kick drums presented as dots on a screen, alongside the number. These data points may support a greater interest and appreciation for how complex music is, as well as providing a greater insight into how powerful the human brain is, since their brain processed all of those sounds unconsciously with no conscious effort on their part. This overall deepens the user's interest in the program, music and the human brain.

FIG. 5 provides a more specific explanation of how the program may build storylines, based on user inputs. The program may be able to overlay anime storylines into the videos it generates, for the purpose of increasing engagement, attention, memory retention and entertainment for the user. FIG. 5 starts from 500 (home screen), which helps explain how the navigation may work. From the starting screen 500, a user may experience the following process.

The user may select a song 501 (such as Immortal by Metrik), then select a subject 502 (such as Neuroscience), and finally select a complexity level of the subject 503 (such as Bachelors). 501 represents a song selection stage of the app, 502 represents a subject selection stage of the app, and 503 represents a complexity selection stage.

The order of the steps in FIG. 5 may change if they have used particular presets, settings, or if the developers program a different functional sequence of the users. Such presets or settings might be that the user has a maths test coming up soon, so they have fixed the program to only offer maths at GCSE level to optimise their experience of the program and save them time when setting up new videos.

After selecting the aforementioned requests 501, 502, and 503, the user may also request a storyline 504. In FIG. 5, the user has decided to be specific about the kind of storyline they would like to see. They have decided to go into the storyline details section, which may state something like ‘Build Storyline or Create Storyline’ 505. The user initially decides on an animation style, which will change the artistic style of the story. In this case they select “anime in the 90 s”, which may be less polished with more matted colours than anime produced 20 years later 506. 506 represents a decision and input by the user about the storyline, specifically the animation style. An example of an anime style might be that of Dragon Ball Z episodes that were developed in the 90s. The program will be developed or trained to understand how to produce characters, backgrounds and animated movements in the style requested. There may be specific programming during the program's development stages, where stored images of martial arts positions are loaded into the servers, such as blocks, strikes and throws, to limit the processing power needed to generate new images and videos.

In this case, the user decides to also provide an input in the Storyline Description section, which may say something like, “What is the story about?” 507. 507 represents a decision and input by the user about the storyline, specifically the description of the story. The user has entered “dramatic gunfight”. The program may be trained or developed to understand how to animate a build up in action, within a storyline. The program may predict that the intro to a song may be a slow zoom in to a character's eye, which the 1st verse may involve the firing of a bullet and the 2nd verse may be the character dodging an attack. It may be trained or programmed to predict that the prompt of “dramatic” requires both action and inaction, and that gunfight also correlates with hiding, dodging, spying and several other activities that don't necessarily involve shooting. The program may also be trained by watching anime TV series and movies, where gunfights have been featured, in order to more readily produce such scenes whilst minimising server and overall computer processing power. The characters in the program may have their movements preloaded via motion capture techniques in order to again minimise server and overall computer processing power.

The user then proceeds to input a character description 508. 508 represents a decision and input by the user about the character that may be included in the storyline. They enter “teenage boy assassin”. The program may predict, via its training or development, that an assassin may have a face covering and hold certain body positions that are unique to assassins it has analysed already. The program may have pre-loaded characters that the developers have generated, which have aspects of their image that can be changed marginally to reflect many different characters whilst again minimising server and overall computer processing power as compared to building and animating characters from scratch. Such changes may be clothing, build, body language and facial features.

After the user has input the animation style 506, storyline description 507, and character description 508, the user may be shown a screenshot, image or text readout of their requested story 509. 509 show a description of what the user will see after they have made the aforementioned inputs throughout FIG. 5. Some users may decide to upload their favourite videos onto the platform, so that others can stream them, rather than loading their own videos. If a user inputs their request and the program has facilitated such a function, the user may be shown videos that are similar to the one they have requested. These videos may be faster to load, may help reduce costs to the user or may just capture the user's attention 509. Overall, this section of the program may give the user the ability to see whether they have selected what they were looking for, prior to requesting their own video to load.

If they confirm the requests have met their expectations, they may confirm this and the storyline will be added to the full video plan, ready to load with the other animated sequences 510. Alternatively, if they choose an existing video to stream, the program will load a video that was already available, that is similar to the video the user requested 510. 510 shows that the storyline will be added to the video plan and may form an important part of the video that helps the user to engage more effectively with the academic materials.

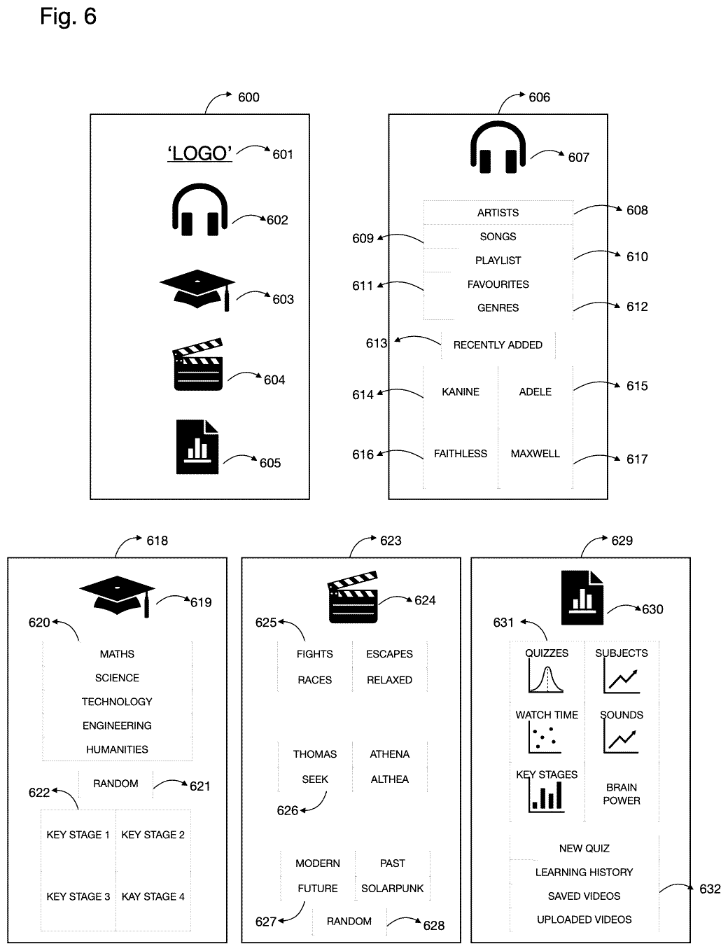

FIG. 6 provides an overview of the example layouts that may be used for some of the primary sections of the program. FIG. 6 enhances the understanding of the program, by alluding to the possible functions, as well as what the user experience may be like when the program has been developed and released.

The elements contained in 600, include a logo 601, and 4 buttons (602, 603, 604, 605) that the user may click on in order to navigate to different areas of the program. The program will be presented in simple, easy-to-use terms for the users, as it will be designed for easy navigation by learners of all ages. The home screen may contain a small number of icons to represent the key aspects of the services offered 600. The icons on the home screen may include the logo of the company and/or product 601, a navigation button to the music section 602, a navigation button to the education section 603, a navigation button to the storylines section 604, and a navigation button to the progress tracking/user profile section 605. There may be other navigation buttons, such as a login/register button. Such a home-screen would allow users of the program to decide where they want to navigate to first, for reasons such as viewing the available material, or for planning a new video. After pressing the music navigation button 602, the program may bring the user to the music section home screen 606.

The elements contained in 606, include a logo that shows the user in a music section of the program 607, and 9 buttons (608, 609, 610, 611, 612, 614, 615, 616, 617). 606 is likely to use a swipe function to make scrolling through different songs and artists easier for the user. This screen may have a similar layout to existing smart phone and tablet media players, where the user can immediately select how they want to begin navigating. There will likely be an indicator that they are in the music section of the program via an icon related to music 607. Examples of this could be things like icons of headphones, speakers, sounds waves or anything generally understood to be related to music and sound. The program will likely offer the ability to navigate via several buttons, through the available music by artist 608, songs 609, playlists 610, favourites 611 and/or by genres 612. Examples of music artists may include Screen Jazzmaster and Lofries. Examples of songs may include Break The Cycle and Baddadan. Examples of playlist may include Study Playlist and High Energy Playlist. Examples of favourites may include Hello by Adele.

The user may also be presented with the music they have recently downloaded or saved, indicated via a text label 613. This is due to the likelihood of their interest in the music they recently downloaded being of higher interest than other music. An example would be that a song the user downloaded earlier on that day would show up higher on this area of the screen than a song the user downloaded a week earlier. In this case, the user has recently downloaded music from multiple genres, including drum n bass 614, pop 615, dance 616 and R&B 617.

The program may offer another home screen specifically for the education section 618. 618 contains a logo 619, a text heading 621, and 9 buttons shown in 620 and 622. This would be made clear via an icon related to education 619. This section would give the users access to different subjects 620, an option to randomise a subject possibly based on their settings 621, or access to subjects that belong within a particular level of learning, or key stage 622. Subjects may include physics, maths and engineering. Levels of learning may include key stage 2, A-Level and Bachelors.

The program may provide a specific home screen for the storyline section 623. 623 includes a logo 624 and 13 buttons shown at 625, 626, 627 and 628. This would be indicated clearly by an icon related to storytelling 624, such as a camera, paintbrush or clapperboard. The user may be provided with options for choosing storylines in many different ways. These navigation options may include types of scenarios and events 625, it may include the focus around a particular character featured in the marketing campaign of the company who own the program 626, and there may be options available about the settings of the video 627. Scenarios and event examples may include fights, chases, escapes or more relaxed scenarios such as walking on a beach. Character examples may be an anime character called Seek, who is an Indian computer hacker with military training, often featured in the anime series clips shown on social media. Examples of settings may be a futuristic city with glass and green spaces, or a present-day setting such as in an airport. Some users may want the program to randomise a scenario, character and setting, so the program may include a randomise button 628 in the education section as well as the education section 621. This may not be entirely random, as it may predict the preferences of the user by their previous prompts. An example of a random video may be a chase scene, featuring a character called Athena, set in a Solarpunk landscape.

629 shows a possible layout for the home screen for the settings and progress tracking section. 629 includes a logo 630, data readouts they may also be navigation buttons 631, and buttons that navigate to other pages containing specific information related to progression 632. The program may serve as a progress tracker for users who have logged in and created profiles. This section would also have its own specific home screen 629 and would likely have a visual icon to indicate to the user which section they are in 630. Examples of this icon could be charts and graphs or an avatar image version of the user themselves. This section would likely contain information that the user finds interesting, as well as information that might tell the user about the level of their progression 631. Such information that would be interesting to the user may include the number of quizzes they have completed, the number of subjects they have learned about, their learning rate compared to other users in their country. The section may provide access to quizzes, history of learning, saved or favourite videos and videos they may have uploaded so other users can view them 632.

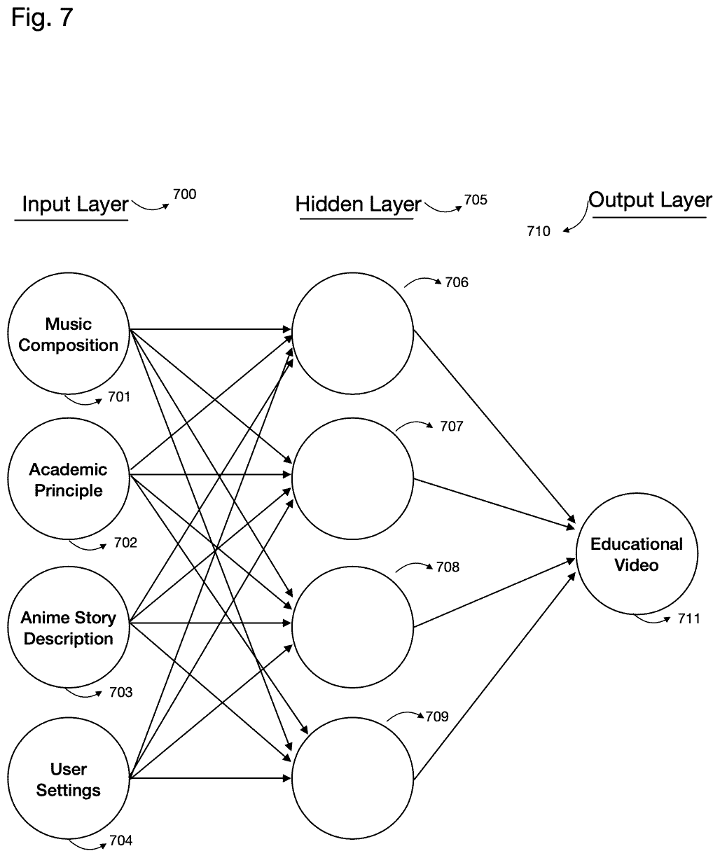

FIG. 7 illustrates a simplified neural network designed for generating educational videos, which integrates music compositions, academic principles, anime story descriptions, and user settings into a unified output. This figure represents an artificial neural network (ANN) architecture, emphasising its capability to process and synchronise diverse types of inputs effectively.

The input layer, labeled 700, consists of four nodes: 701 for music composition input, such as a song by Etherwood; 702 for the input of academic principles, like the concept of geometry; 703 for anime story descriptions, like a solar-punk fight scene; and 704 for user settings, possibly specifying parameters such as target age group and desired level of repetition in videos. These nodes facilitate the entry of varied data into the system.

Within the ANN, the hidden layer, indicated by 705, features nodes 706, 707, 708 and 709. Despite the simplified depiction of only four nodes within only a single hidden layer, the hidden layer in FIG. 7 embodies a complex processing unit where one of the key functionalities includes the advanced matching of musical notes and musical elements with the academic content's presentation. There may be a number of hidden layers and/or nodes within such hidden layers, that is beyond the scope of what can be shown in a single diagram. Specifically, this layer processes the synchronisation of individual musical notes and elements with dynamic academic material presentation, including the animation, separation, and reassembly of diagrams in time/rhythm with the music. This capability relies on a combination of training techniques, such as pre-training on relevant datasets, reinforcement learning from human feedback, and retrieval augmented generation, to achieve nuanced content synchronisation.

The system's output, represented by node 711 in the output layer 710, synthesises the processed inputs into an educational video. This video leverages the processed inputs to create a learning experience where music and visual content are intricately aligned. For example, the animation of geometry concepts could be timed to the flow of the music, enhancing comprehension and retention.

This neural network's development may involve collaboration among software engineers, subject matter experts, education specialists, and AI scientists. Their combined expertise may ensure that the system's functionality not only integrates various inputs but also pairs musical elements with educational content in a way that facilitates superior learning outcomes and aesthetics. The depiction in FIG. 7, while streamlined, outlines the potential of the ANN to utilise complex input processing and training techniques for educational video production, highlighting the system's sophisticated approach to learning material presentation.

The technology described here relates to a software program, possibly a generative artificial intelligence model, that uses advanced music analysis to structure the presentation of visual academic materials, for the purpose of improving learning outcomes. The use of a computer, tablet, smartphone, glasses or any available form of technology can be used by people for obtaining audio and visual information. The program preferably uses highly specialised animation techniques and music analysis techniques, in order to incorporate mnemonic techniques under a single platform, examples of which are listed and defined as follows.

High-Frequency Supraliminal Melodic Learning: Supraliminal refers to stimuli or messages that are above the threshold of conscious perception, meaning they are detectable by the conscious mind. Melodic learning is an educational approach that integrates music and melody into the teaching process to enhance memory retention and engagement. High-frequency supraliminal melodic learning is a novel learning protocol that may use 10 s-100 s-1000 s of individual sounds or elements in music in rapid succession and/or simultaneously, to present visual material at a high frequency. As the brain detects sounds faster than words, the visual imagery may be ‘dropped’ onto a higher speed auditory pathway, via the ability of the brain to create associations between, and ordering of stimuli that is received alongside other stimuli.

High-Frequency Music-Encoded Spatial Learning: Spatial learning involves acquiring and understanding information about one's environment and spatial relationships between objects, facilitating navigation and memory of physical spaces. This requires visualisation either in reality or in the mind's eye (internal visualisation) of an object or location. Music-encoded spatial learning in the program is a novel method of spatial learning, that time-pairs the presentation of images, including multiple parts of the same image, with the sounds or elements in music. Due to the 100 s-1000 s of individual sounds and elements in many music compositions, the time-pairing of visual elements of objects, locations or other visual material can be animated to a high frequency. This creates the ability to show a learner 100 s-1000 s of images, sometimes of the same object or diagram, that will improve their visual-spatial memorisation ability beyond what is normally possible.

Music-Encoded Acronyms: Acronyms are abbreviated forms of phrases, created using the initial letters of each word in the phrase, which are pronounced as a single word, and time-paired with notes or elements of music. Music-encoded acronyms present the acronym visually at the same time as a note or element of a musical composition is played, for the purpose of improving learning and memory via the combining of melodic learning and acronyms together.

Music-Encoded Optimised Chunking: Chunking is a cognitive strategy that involves breaking down information into smaller, manageable units or groups, making it easier to process, understand, and remember. Music-encoded chunking involves the presentation of units or groups of information at the same time as notes or elements of music are played. Optimised chunking involves the improvements in the grouping of information via an initial development of chunks and an ongoing feedback mechanism from single and multiple users regarding how effective the grouping of information was to them.

Advanced Music Analysis: Advanced music analysis is the breaking down of music into visually understandable geometric patterns that represent the individual notes or sounds that occur throughout an entire musical composition. This includes every sound, including all drums, synths, vocals etc, but also extends to include things such as the syllables of the vocals, the changing focal point of the music, as well as the general structure.

Musically-Animated High Detail 2D & 3D Academic Models: The program may have stored models of diagrams available that are of a level of detail that is higher than any other computer program, textbook or image. The level of detail can be explained in the case of a 3D model to be closely resembling the structure as it is found in reality, meaning that a user of the program can zoom into an image and continue to see further details as they zoom further in. All the component parts of the models may then be animated in time to the sounds and elements of music, providing the animation with a time-pairing mechanism which may result in greater learning outcomes.

### Example

In its simplest terms, the disclosed technology will detect the number of sounds/notes (or musical elements) that are played within a music composition or audio file. It will then organise a body of academic information, such as from a textbook, based on the number of sounds/notes within the song, and will then visually express that information, in time to the musical sound/note sequence. The simplest example of this would be a song with the lyrics “Hello, My Name Is”, that repeats often in a chorus. A subjects might be Maths at Key Stage 1. The program may predict that the equation 2+2=4 can be separated into 5 parts. Part 1 is the number ‘1’, part 2 is a ‘+’ symbol, part 3 is the number ‘2’, part 4 is an ‘=’ sign, and part 5 is the number ‘4’. In this case the program is trained on words and syllables, and analysis that there are 5 syllables in the 4 words that make up the lyrics “Hello, My Name Is”. The program will then predict that He=2, Llo=+, My=2, Name==, Is=4. The program will show, highlight in some way, or animate those aspects of the equation, in time with the lyrics. For more complex subjects, using the same lyrics, the program may use chunking (grouping of complex information into more manageable bites) and animate a more complex academic idea or principle using the same 4 words and 5 syllables. The purpose is to help the user's brain learn more easily.

### Elements of Music

Although the descriptions contained here will focus on a simplified method of pairing the sounds/notes in music with the timing, animation and/or presentation of academic material for the purpose of learning and entertainment, there are other elements of sound that may also be used to do this. The following are brief descriptions of some of the elements of music, as understood by musicians and other people who are familiar with music theory.

Melody, is the main tune or series of notes that are perceived as a single coherent entity.

Harmony, the combination of simultaneously sounded musical notes to produce chords and chord progressions, adding depth and support to the melody.

Rhythm: The pattern of sounds and silences in music, created by the arrangement of notes and beats in time.

Dynamics: The variations in loudness and intensity within a piece of music, ranging from soft (piano) to loud (forte).

Texture: The interrelationship of different musical lines or voices within a composition, including monophonic (single melodic line), homophonic (melody with accompanying harmony), and polyphonic (multiple independent melodies) textures.

Timbre: The quality or color of sound that distinguishes one instrument or voice from another, allowing for variety and richness in musical expression.

Form: The overall structure or organization of a musical composition, including elements like repetition, contrast, and development.

Tempo: The speed or pace at which music is played, providing a sense of rhythm and energy.

Expression: The emotional or interpretative aspects conveyed through musical performance, including dynamics, articulation, and phrasing.

Throughout the descriptions, the term notes or sounds may also be applied to the elements of music contained in this list above this paragraph. These elements of music are particularly important as the program becomes more advanced and is able to predict how information should be time-paired for the best results for the user's learning process.

### Prediction of Elements Based on Psychological Profile

The program will preferably be able to use machine learning and algorithms, fed by the user's inputs, reactions and results of watching the education videos the program produces, to optimise the use of music to transfer information to the user's brain. For this reason, over time, the program may depart from a standardised time-pairing method such as using notes and sounds to time the presentation of academic material. The program may receive user input and feedback that guides it to making predictions that other attributes/elements of music could be more useful as pairing mechanisms. This could include a prediction that when vocals are encoded with academic material, the user benefits greatly, but this changes if there is a strong background melody or riff playing at the same time. The program in this case, may predict how to encode the academic materials onto both the vocals and the riff/melody in the background.

If a long sequence in biochemistry is animated for example, which might be 10 steps, the first 5 steps might be sequenced to vocals. In a song where the vocals then drop off, leaving the most prominent aspect of the music as drums for a few seconds, then the next 5 stages of the biochemistry sequence might be time-paired with drums. The program may make predictions about the points where the vocals are at the front of the song, vs when the riff/melody in the background pushes forward to become the most attention-grabbing aspect of the music, such as between the utterance of different words in the lyrics. Accordingly, there might be a powerful riff that pushes forward in conjunction with the lyrics. The program may predict that the lyrics should be time-paired with the animation of certain parts of a diagram, whilst the riff notes should be time-paired with the animation of a separate set of parts from the same diagram. This prediction ability may make the program more capable of encoding academic material into the human brain in less time, with greater retention.

To summarise, the program may primarily use a simple process of using individual notes or sounds in music to determine the timing of visual material, but it may also use other elements of music. The program may include the prediction, and the ability to blend all of the elements of music with academic materials, based on programming, user preferences and user results.

### Pairing of Music & Academic Subjects vs Time-Pairing Detailed Musical Elements

Although it is understood that music has an effect on the brain, driving emotion, associations and improving cognition, the technology described here uses music more specifically Each day, thousands of students may select a song to listen to and then select a subject to study. The student has paired the musical composition or a playlist, with an academic subject, for the purpose of achieving greater learning outcomes. This may be because it makes them feel more relaxed, or it may provide background noise which helps them to fill their senses with more consistent input of sound, making other sounds like planes, doors and voices less distracting.

Users of the program will preferably receive auditory and visual stimuli at the same time as they watch the video. This means that information will travel down both the auditory and visual pathways in the brain at the same time. This creates an association between the sounds and the images, as the brain has evolved to group information together that appears to be relevant or related to other information. Since music may contain many 100 s-1000 s of sounds/elements every minute, it is the high-detail time-pairing method of the disclosed technology that facilitates a possibility for significantly greater information input than may be possible via reading or listening to words alone.

The disclosed technology relates to a digital software program, including but not limited to a generative AI model, or a collection of models, that use the individual sounds/elements in music audio files or project files (the files that show all of the notes and instruments laid out visually in music production software), to time the on-screen presentation of academic materials, for the purpose of improving human cognitive processing and memory, to a higher degree than presenting the information separately. The academic materials will be optimised for learning, and then presented based on the number of sounds or elements in music. The experience of the user, will preferably be listening to the audio of a piece of music, but with the images, words and diagrams from a subject of choice projected, sequenced and summarised on-screen, in time with various elements of the sounds in the music. The screen may be a computer, phone, tablet, goggles, glasses or any other form of technology that humans may use to present visual information.

The software program preferably allows the user to select of song of their choice to learn to, as one step. Another step would involve the selection of an academic subject, or any other subject they desire to learn about. A third step would involve the selection of a complexity level, such as an academic Key Stage, about a particular subject, to match the age and/or the user's pre-existing knowledge about the subject in question. More detailed features could also be selected, including but not limited to a) the amount of repetitions of academic materials, b) the amount of text vs the amount of animated images, c) the inclusion of a storyline to help with context about the subject, d) what instruments the academic material should be sequenced to.

The software program preferably analyses the note patterns contained in music, music audio files and/or music project files (the latter from music production software), and recognises the instruments and the sequences of notes, tones and musical elements throughout the song. The software program preferably translates the sounds within the music into individual visual geometric patterns, which may be viewed by a user of the program if they wish. These patterns will show how academic materials can be sequenced, since each segment of the geometric pattern can then be encoded with information and timed to the notes played by each instrument. The user may decide to manually adjust, possibly via a drag and drop action on a screen, the way the program will link the academic material with the sounds and elements of the music. This could involve the user dragging the animation of a diagram from being time-paired with the vocals of a song, onto the drum pattern of a song. This may make the diagram animating occur in a much higher frequency, allowing for more repetition.

The software program preferably has stored information within it about academic subjects and other information users of the program may wish to learn. The program may be a generative AI model with training on songs, and on online academic textbooks, including the text, charts, diagrams and any other information. The program may have substantial and ongoing programming that enable it to optimise the presentation of academic materials, to make learning outcomes better for users of the program. The program may be able to visually sequence the academic material on any form of viewable screen, by using the audible geometric patterns from the analysis of the music audio, music audio file or music project file. If a user of the program provides a number of specific prompts, the program will target more specific information, limiting the total amount of information it transfers onto the audible geometric pattern that sequences the visual information on-screen. This may lead to more repetition of the same information, which may benefit the user's learning outcomes. The program can also provide a more general body of information if the user does not prompt the program more specifically.

The program may be able to summarise text, to reduce the word-count heavily for the viewer. The program may be able to animate diagrams, by highlighting (e.g. lighting up or zooming in) different aspects of diagrams in sequences that the user of the program may need to learn. The program will have a storage of visually numerical dot sequences (subitising), which may be used to simplify mathematical equations. These dots will help to engage visual-spatial memory and will be presented as various patterns of circles or other shapes, similar to how numbers are present on a dice. The program may have several artistic animated backgrounds and several characters that may be involved in storytelling, for the purpose of driving emotional engagement and adding a contextual framework to enhance learning outcomes. There will be multiple iterations of the program, with the first version including some functions, with more added in as the program develops and becomes more advanced.

The aforementioned geometric patterns, generated from music, preferably serve as a plan for how the information will show up on screen, ready for when the user plays the music video.

1. A data processing method of generating a structured audio-visual presentation of educational material data, integrated with musical data, for output onto a display, comprising steps of:
(a) receiving a block of musical data representing a specific musical work;
(b) receiving a block of educational material data representing a specific educational material;
(c) processing the received block of musical data to determine and isolate musical elements contained in the block of received musical data to thereby generate a determined structure of the received block of musical data, including notes played by a plurality of instruments and vocal sounds including words and syllables in such vocal sounds;
(d) processing the received block of educational material data to determine and isolate educational material elements contained in the received block of educational material data to thereby generate a determined structure of the received block of educational material data, including text and diagrams associated with the text; and
(e) processing the determined and isolated musical elements in the received block of musical data and the determined educational material elements in the received block of educational material data, to determine synchronized time pairings of specific individual musical elements with specific individual educational material elements, by using the determined structure in the determined and isolated musical elements from step (c) and the determined structure in the determined and isolated educational material elements from step (d), where the determined synchronised time pairings are ordered sequentially for presentation onto the display as an audio-visual presentation.

2. The method of claim 1, wherein the steps (a) through (e) are carried out by an artificial neural network including:
(i) an input layer for receiving the block of musical data and the block of educational material data;
(ii) at least one hidden layer for performing the processing steps; and
(iii) an output layer for outputting a result of the processing steps for presentation onto the display.

3. The method of claim 1, wherein the audio-visual presentation includes at least one geometric pattern representing the received block of musical data.

4. The method of claim 1, wherein the method further includes a step of receiving a specified level or area of interest related to the specific educational material.

5. The method of claim 1, wherein the method further includes a step of receiving a storyline, including attributes comprising characters, art style and plot.

6. The method of claim 5, wherein the storyline is an anime cartoon storyline.

7. The method of claim 1, wherein the processing step (e) results in generating a video plan, setting out specific data regarding how the audio-visual presentation will be presented and played on the display.

8. The method of claim 7, further including a step (f) of presenting the video plan onto the display to review and edit the video plan.

9. The method of claim 6, wherein characters from the received storyline are presented onto the display with animated educational material encoded onto at least one character.

10. The method of claim 9, wherein the at least one character is presented in the audio-visual presentation as moving in response to the determined structure of the received block of musical data.

11. The method of claim 1, wherein the steps (a) and (b) include receiving the blocks of data from a user, in response to the user being presented with options for selection on the display.

12. The method of claim 7, wherein the video plan includes a music stem file.

13. The method of claim 7, wherein the video plan includes written data points describing a result of the processing at steps (c) or (e), including a total number of sounds which have been identified by the processing.

14. A system comprising means adapted for carrying out all the steps of the method according to claim 1.

15. A computer program stored on a computer readable storage medium comprising instructions for carrying out all the steps of the method according to claim 1, when said computer program is executed on a computer system.
